(19) United States
(12) Patent Application Publication
(10) Pub. No.: US 2013/0202772 A1
(43) Pub. Date: Aug. 8, 2013

(54) GRANULAR POWDER

(71) Applicants: Yasuyuki Yoshioka, Tokyo (JP); Makoto Kondo, Tokyo (JP)

(72) Inventors: Yasuyuki Yoshioka, Tokyo (JP); Makoto Kondo, Tokyo (JP)

(73) Assignee: NISSHIN FOODS INC., Tokyo (JP)

(21) Appl. No.: 13/879,186

(22) PCT Filed: Sep. 11, 2012
(86) PCT No.: PCT/JP2012/073144

§ 371 Date: Apr. 12, 2013

(30) Foreign Application Priority Data
Sep. 12, 2011 (JP) 2011-197814

(51) Int. Cl. A23L 1/10

(52) U.S. Cl. CPC A23L 1/1041
USPC 426/622

(57) ABSTRACT

Provided is a granular powder for a food product containing wheat flour, the granular powder: having good adhesion to food materials when used for coating them without causing scattering of powder, thereby attaining good handling properties; achieving both a light and soft texture inside and a crispy texture on the surface; and further, being capable of maintaining a favorable texture even some time after cooking. Also disclosed is a granular powder obtained by subjecting wheat flour and dextrin to hydrothermal treatment.

### TECHNICAL FIELD

The present invention relates to a granular powder, more specifically to a granular powder for a food product containing wheat flour such as a deep-fried food including tempura, a deep-fried breaded food, and karaage (deep-fried seasoned food), a pan-fried or baked food including okonomiyaki (Japanese style pizza), a pancake, and a bakery product, a steamed food, a variety of sauces, and a food binding agent.

### BACKGROUND ART

A deep-fried food such as tempura, a deep-fried breaded food, and karaage is produced by coating a pure or seasoned ingredient directly with a coating material such as flour, starch, and seasonings or with a coating material in the form of a batter, and cooking the resulting ingredient in oil. For a deep-fried food, adhesion to ingredients, uniform color after frying, a crispy texture, and the like are demanded. Also, a pan-fried or baked food such as okonomiyaki, a pancake, and a bakery product is demanded to satisfy a variety of batter qualities, for example a crispy, flavorful and firm texture on the surface with the light and soft yet chewy inside. Other food products containing wheat flour are also demanded to have a soft and smooth texture, and the like. Meanwhile, generally, wheat flour and a mix containing wheat flour are likely to cause problems such as flying away and scattering around or, conversely, aggregating into lumps. Therefore, an operational improvement is demanded for, for example, successfully mixing wheat flour or a mix containing wheat flour uniformly with other ingredients without causing scattering of powder.

In light of the above, there is a demand for provision of a granular powder containing wheat flour which can give a food product containing wheat flour a crisp texture on the surface and a soft texture inside and which is mixed well with other ingredients and is easily used for cooking.

Various modifications have been attempted in order to impart or improve the aforementioned demanded qualities. With regard to karaage, wheat flour and starch, which are the main ingredients, are prepared in advance, and further, a karaage mix is provided, which contains the aforementioned prepared wheat flour and starch mixed with salt, seasonings, spices, and the like in advance and can provide karaage conveniently only by directly coating ingredients with this karaage mix and cooking them in oil.

For example, Patent Literature 1 discloses a coating-type granular powder for karaage containing pregelatinized starch. However, there was a problem that karaage produced using this granular powder for karaage developed a soggy texture when it got cold some time after cooking in oil. Also, Patent Literature 2 discloses a composition for a deep-fried food containing the reduced form of dextrin having a dextrose equivalent of 20 or less. However, because the reducing terminal of sugar contained in this composition is reduced, this composition fails to undergo Maillard reaction, which is crucial for the flavor of food. As a result, there was a problem that food prepared using this composition was unsatisfactory in terms of flavor. Also, Patent Literature 3 discloses hydrothermally treated wheat flour for a deep-fried food, wherein the wheat flour is hydrothermally treated and has a pregelatinization degree of 12.5 to 30% and a viscosity of 1 to 10 Pa·S when the water is added in an amount of 300% by mass relative to the flour. However, the actual situation was that even when karaage was cooked after coating with this wheat flour, the powdery quality of the coating was unsatisfactory. Also, Patent Literature 4 discloses a quality-improving agent for takoyaki (ball shaped Japanese snack made of wheat flour-based batter and typically filled with minced or diced octopus) or okonomiyaki containing dextrin having a specific quality. However, a food product obtained from a raw material powder to which dextrin is merely added was found to have a sticky, heavy texture.

### CITATION LIST

### Patent Literature

[Patent Literature 1] JP-A-2005-333861
[Patent Literature 2] JP-A-2001-128635
[Patent Literature 3] JP-A-2008-67675
[Patent Literature 4] JP-A-2010-154800

### SUMMARY OF INVENTION

### Technical Problem

The present invention was made in view of the aforementioned problems and actual situations. An object of the present invention is to provide a granular powder for a food product containing wheat flour, the granular powder: having good adhesion to food materials when used for coating them without causing scattering of powder, thereby attaining good handling properties; achieving both a light and soft texture inside and a crispy texture on the surface; and further, being capable of maintaining a favorable texture even some time after cooking.

### Solution to Problem

That is, the present invention provides a granular powder obtained by subjecting wheat flour and dextrin to hydrothermal treatment.

The present invention also provides a wheat flour composition containing the granular powder.

The present invention also provides a method for producing a food product containing wheat flour, including adding the granular powder to an ingredient.

The present invention also provides a method for producing a premix for the production of a food product containing wheat flour, including adding the granular powder to an ingredient.

The present invention also provides a method for improving the texture of a food product containing wheat flour, including adding the granular powder to an ingredient.

### Advantageous Effects of Invention

When the granular powder of the present invention is used, it has good adhesion to food materials when used for coating them without causing scattering of powder, thereby attaining good handling properties. Also, use of the granular powder of the present invention enables production of a food product containing wheat flour which achieves both a light and soft texture inside and a crispy texture on the surface, and moreover, can maintain a favorable texture even some time after cooking.

### DESCRIPTION OF EMBODIMENTS

The granular powder of the present invention is obtained by mixing wheat flour and dextrin, and then subjecting the resulting mixture to hydrothermal treatment.

A wheat flour to be used as the raw material of the aforementioned hydrothermally treated granular powder of the present invention may be wheat flour which is commonly used in food products, examples thereof include hard wheat flour, semi-hard wheat flour, moderate wheat flour, soft wheat flour, durum wheat flour, and a mixture of these flours, and they can be appropriately selected and used.

As the dextrin to be used as the raw material of the aforementioned hydrothermally treated granular powder of the present invention, one prepared by a publicly known method using starch as the raw material can be used. Examples of the raw material starch include starch such as tapioca, potato, wheat, corn, and waxy corn, and a mixture of these starches. As the aforementioned raw material dextrin, one having a dextrose equivalent (DE value) of 2 to 25 is preferable, and one having a dextrose equivalent (DE value) of 5 to 20 is more preferable. When the DE value is less than 2, tempura and karaage produced using the resulting granular powder will tend to have a light color after frying and be soggy, while when the DE value exceeds 25, tempura and karaage will tend to have a dark color after frying and the texture will tend to be too hard. Also, in the production of a pancake and okonomiyaki, when the above DE value of dextrin is less than 2 or more than 25, the texture of the pancake and okonomiyaki thus produced is not sufficiently improved. A preferred DE value of dextrin can be regulated by hydrolyzing the raw material starch in a stepwise manner while measuring the amount of glucose.

The granular powder of the present invention can be prepared by subjecting a mixture of the aforementioned wheat flour and the aforementioned dextrin to hydrothermal treatment. As the method of the aforementioned hydrothermal treatment, a method of heat treatment including adding water or steam to a mixture of wheat flour and dextrin may be used. Examples of the method of hydrothermal treatment include a method including filling a hermetic container with hydrated wheat flour and dextrin, and while stirring as needed, applying heat treatment using saturated steam in a pressurized state, a method including adding water to wheat flour and dextrin and kneading the resulting product while heating using a uniaxial or biaxial extruder, and a method including performing heat treatment under a saturated steam atmosphere using an apparatus such as the one described in JP-A-2009-34038.

Examples of the heat treatment under a saturated steam atmosphere include superheated steam treatment, for example, a method including appropriately adding water to wheat flour and dextrin, hermetically sealing the resulting product in a hermetic container such as an aluminum pouch, and then applying heat to the resulting container under pressure. It should be noted that the amount of water to be added as described above may be 2 to 20% by mass, preferably 5 to 15% by mass relative to the total amount of wheat flour and dextrin. As to the conditions of the aforementioned heating, for example, heating may be performed at 20 to 30 kPa (a gauge pressure of 20 to 30 kPa in the apparatus described in JP-A-2009-34038) and a temperature of 100 to 120° C. for 3 seconds to 1 minute, preferably at a gauge pressure of 22 to 28 kPa and a temperature of 103 to 115° C. for 5 to 15 seconds. When the temperature is below 100° C., the texture of the coating of the tempura and karaage produced using the resulting granular powder becomes soggy when the foods get cold. Meanwhile, when the temperature is above 120° C., there is a fear that the color of karaage after frying might become dark and the texture might be too hard. Further, when the temperature is below 100° C., there is a fear that adhesion of the resulting granular powder to food materials might be reduced.

By hydrothermal treatment as mentioned above, a granulated material can be obtained while gelatinizing starch contained in wheat flour. The granulated material thus obtained may be preferably used after drying. Examples of the method of drying include a method such as shelf-drying, hot-air drying, and fluidized bed drying, and a method of drying may be appropriately adopted according to the method of hydrothermal treatment. After drying, the particle diameter of the granulated material is appropriately adjusted by a publicly known method. The particle diameter may be, for example, as an average particle diameter, 50 to 400 preferably 70 to 300 μm, and the particle diameter can be adjusted by sifting the granulated materials through a sieve having a mesh corresponding to the desired average particle diameter. Preferably, a sieve having a 30 to 100 mesh may be used. Large-sized particles may be subjected to pulverization treatment by a variety of pulverization means such as roll crushing and pin mill crushing, and then once again sifting through a sieve and the like. When the average particle diameter is less than 50 μm, there is a fear that the texture of karaage produced using the resulting granular powder might be poor in powdery quality (the appearance of the powdery surface of the coating, which is characteristic of karaage) as well as in coating quality (the appearance of a rough surface as if fine particles are uniformly attached on the surface, which is characteristic of karaage). Meanwhile, when the average particle diameter is more than 400 μm, there is a fear that the texture of the resulting karaage might be too hard.

The granulated material thus obtained is the granular powder of the present invention. The mass ratio of the hydrothermally treated wheat flour and the hydrothermally treated dextrin in the granular powder of the present invention may be in a range of 100:5 to 20, preferably 100:8 to 12 as the mass ratio of wheat flour and dextrin before hydrothermal treatment. When the aforementioned mass ratio of dextrin is smaller than 5, there is a fear that karaage produced using the resulting granular powder might have a texture poor in powdery quality and coating quality. Meanwhile, when the aforementioned mass ratio of dextrin is more than 20, there is a fear that tempura and karaage might have a dark color after frying. Also, in the production of a pancake and okonomiyaki, when the above mass ratio of dextrin is less than 5 or more than 20, the texture of the pancake and okonomiyaki thus produced is not sufficiently improved.

The granular powder of the present invention can be provided as a wheat flour composition as a mixture containing other ingredients, as needed. The granular powder or the wheat flour composition containing the same according to the present invention can be used for the production of a variety of food products containing wheat flour as the ingredient of the coating material of a deep-fried food such as tempura, a deep-fried breaded food, and karaage, a batter of a pan-fried or baked food such as okonomiyaki, a pancake, and a bakery product, a steamed food represented by steamed bread, a variety of sauces such as white sauce, and a food binding agent for a nerimono (a boiled fish-paste product). The granular powder or the wheat flour composition containing the same according to the present invention has good handling properties since it has good adhesion to food materials when used for coating them, while causing reduced scattering of powder.

The wheat flour composition of the present invention can appropriately contain, in addition to the aforementioned hydrothermally treated wheat flour and dextrin, a necessary component in the aforementioned food ingredients, for example, grains such as untreated wheat flour, corn flour, white sorghum, and rice powder; starches such as tapioca, potato, wheat, corn, and waxy corn, and starches obtained by subjecting the above starches to chemical or processing treatment such as acetylation, etherification, cross-linking, oxidation, and pregelatinization; sugars (for example, monosaccharides, disaccharides, oligosaccharides, dextrin, and sugar alcohol); thickening agents; leavening agents; seasonings; spices; dyes; and fragrances, as needed.

Accordingly, the aforementioned wheat flour composition can be provided as a premix for the production of a food product containing wheat flour. Examples of the premix include a karaage powder or tempura powder for the production of the coating material of a deep-fried food such as tempura, a deep-fried breaded food, and karaage; a powder mix for the production of a pan-fried or baked food such as an okonomiyaki mix, a bakery mix, and a pancake mix; a mix for a steamed food such as steamed bread; and a sauce mix for the production of a variety of sauces such as white sauce. Preferably, the above premix can be a karaage powder, a pancake mix, or an okonomiyaki mix. Preferably, this karaage powder can be a coating-type karaage powder.

For example, in the case of the coating-type karaage powder, an additive which has been mixed in conventional karaage powders such as wheat flour, sugars (for example, monosaccharides, disaccharides, oligosaccharides, dextrin, and sugar alcohol), seasonings (for example, salt, powdered soy sauce, amino acid, chemical seasonings, and natural extracts), spices (for example, pepper powder, garlic powder, ginger powder, and chili pepper powder), and dyes (for example, paprika dye) may be added to and mixed with the aforementioned granular powder of the present invention, as needed. The amount of these additives added may be the same as the amount of additives added to conventional karaage powders, and the amount may be preferably 15.0 to 30.0% by mass in total. In other words, the content of the granular powder of the present invention in the above karaage powder may be preferably 70.0 to 85.0% by mass.

Also, for example, in the case of a pancake mix, an additive which has been mixed in conventional pancake mixes such as wheat flour, sugars (for example, monosaccharides, disaccharides, oligosaccharides, dextrin, and sugar alcohol), seasonings (for example, salt), leavening agents (for example, baking powder), and dyes (for example, gardenia dye) can be added to and mixed with the aforementioned granular powder of the present invention, as needed. The amount of these additives added may be the same as the amount of additives added to conventional pancake powders, and the amount is preferably 90 to 95% by mass in total. In other words, the content of the granular powder of the present invention in the above pancake mix may be preferably 5.0 to 10.0% by mass.

Also, for example, in the case of a gratin mix, an additive which has been mixed in conventional gratin mixes such as wheat flour, sugars (for example, monosaccharides, disaccharides, oligosaccharides, dextrin, and sugar alcohol), seasonings (for example, salt, powdered soy sauce, amino acid, chemical seasonings, and natural extracts), spices (for example, pepper powder, garlic powder, and chili pepper powder), and dyes (for example, paprika dye) can be added to and mixed with the aforementioned granular powder of the present invention, as needed. The amount of these additives added may be the same as the amount of additives added to conventional gratin mixes, and the amount is preferably 60 to 80% by mass in total. In other words, the content of the granular powder of the present invention in the above gratin mix may be preferably 20.0 to 40.0% by mass.

Also, for example, in the case of an okonomiyaki mix, an additive which has been mixed in conventional okonomiyaki mixes such as wheat flour, sugars (for example, monosaccharides, disaccharides, oligosaccharides, dextrin, and sugar alcohol), oils and fats, protein components such as powdered milk and egg powder, soy protein, and wheat gluten powder, seasonings (for example, salt), leavening agents (for example, baking powder), and dyes (for example, gardenia dye) can be added to and mixed with the aforementioned granular powder of the present invention, as needed. The amount of these additives added may be the same as the amount of additives added to conventional okonomiyaki, and the amount is preferably 90 to 95% by mass in total. In other words, the content of the granular powder of the present invention in the above okonomiyaki mix may be preferably 5.0 to 10.0% by mass.

The wheat flour composition of the present invention can be used in a similar manner to a variety of conventional powder mixes for food products. For example, similarly to conventional karaage powder mixes, the aforementioned karaage powder can be used by directly coating ingredients commonly used for karaage such as chicken, pork, beef, fish, and shell fish. Further, the aforementioned pancake mix and gratin mix as well as other mixes such as an okonomiyaki powder, a bakery mix powder, and a variety of sauce mixes can also be appropriately mixed with other ingredients and used for preparing batter, sauce, and the like in a similar manner to those conventionally used powder mixes.

A variety of food products containing wheat flour such as karaage, a pancake, gratin, okonomiyaki, and a bakery product can be obtained by cooking the ingredients, batters, and sauces thus obtained by a common method.

A food product containing wheat flour produced using the granular powder of the present invention or a wheat flour composition containing the same achieves both a light and soft texture inside and a crispy texture on the surface, and further, can maintain a favorable texture even some time after cooking.

### EXAMPLES

Hereinbelow, the present invention will be described further in detail with reference to Examples; however, the present invention is not limited only to these Examples.

### Examples 1 to 2

Raw materials composed of wheat flour (soft wheat flour) and dextrin (DE value: 12) as shown in Table 1 were put into the apparatus described in JP-A-2009-34038 and water was added in an amount of 10% relative to the total amount of wheat flour and dextrin, followed by hydrothermal treatment for 5 seconds under the conditions of a gauge pressure of 25 kPa at 105° C. After the hydrothermal treatment, the resulting products were dried, cooled, and then sifted through a sieve with a 26 mesh or 30 mesh, whereby granular powders each having an average particle diameter of 80 μm (Example 1) or 180 μm (Example 2) were produced.

### Comparative Examples 1 to 2

Except for using a raw material composed only of wheat flour (soft wheat flour) or wheat flour and pregelatinized starch (potato starch) as shown in Table 1, granular powders each having an average particle diameter of 70 μm or 80 μm were each produced in the same manner as Example 1.

### Comparative Example 3

Only wheat flour (soft wheat flour) was subjected to hydrothermal treatment by the same procedure as in Example 1, and the resulting wheat flour was mixed with dextrin not having been subjected to hydrothermal treatment, followed by sifting the mixture through a sieve, whereby a granular powder having an average particle diameter of 75 μm was produced.

### Comparative Example 4

Separate hydrothermal treatment of each of wheat flour and dextrin was attempted by the same procedure as in Example 1. However, independently hydrothermally treated dextrin absorbed moisture, making production difficult. As a result, a granular powder could not be obtained.

TABLE 1

| Raw material | | | Comparative | Comparative | Comparative | Comparative |
|---|---|---|---|---|---|---|
| (% by mass) | Example 1 | Example 2 | Example 1 | Example 2 | Example 3 | Example 4 |
| Wheat flour | 90 | 90 | 100 | 100 | 90 | 90 |
| (soft wheat | | | | | | |
| flour) | | | | | | |
| Dextrin | 10 | 10 | — | — | 10 | 10 |
| DE value | 12 | 12 | — | — | 12 | 12 |
| Pregelatinized | — | — | — | 10 | — | — |
| starch | | | | | | |
| Hydrothermal | Wheat | Wheat | Only wheat | Wheat flour + | Only wheat | Wheat |
| treatment | flour + | flour + | flour | Starch | flour | flour + |
| | Dextrin | Dextrin | | | | Dextrin |
| | Mixture | Mixture | | | | Each |
| | | | | | | separately |
| Particle | 80 | 180 | 70 | 80 | 75 | — |
| diameter of | | | | | | |
| granular | | | | | | |
| powder | | | | | | |

### Test Example 1

The surface of about 25 g of chicken thigh was evenly coated with the granular powders of Examples 1 to 2 or Comparative Examples 1 to 3, and chickens were left for 3 minutes to allow the powders to sufficiently cling to the chicken. Subsequently, the granular powder-coated chickens were deep-fried in salad oil heated to 160 to 170° C. for 3 minutes, whereby chicken karaage was produced. 10 Panelists evaluated the texture of the meat and the appearance and texture of the coating of the karaage thus obtained, and average scores were obtained. Also, after storing the cooked karaage for 3 hours at room temperature, the texture of the coating was evaluated based on the same standard. Further, adhesion and handling ease of the granular powder during cooking were also evaluated. The evaluation criteria used above and evaluation results are shown in Tables 2 and 3, respectively.

TABLE 2

| Evaluation item | Score | Evaluation criteria |
|---|---|---|
| Texture of meat | 5 | Very soft, juicy, excellent texture |
| | 4 | Soft and good texture |
| | 3 | Slightly hard but fair texture |
| | 2 | Hard and poor texture |
| | 1 | Very hard and very poor texture |
| Appearance and | 5 | Excellent powdery quality and coating |
| texture of coating | | quality and non-greasy, crispy, and |
| | | excellent texture |
| | 4 | Have powdery quality and coating quality, |
| | | and non-greasy and slightly crispy texture |
| | 3 | Slight powdery quality and coating quality |
| | | and fair texture |
| | 2 | Poor powdery quality and coating quality, |
| | | greasy, sticky, and soggy texture |
| | 1 | Very poor powdery quality and coating |
| | | quality and very greasy, sticky, and |
| | | soggy texture |
| Texture of | 5 | Non-greasy and excellently crispy texture |
| coating (after 3 | | was maintained |
| hours of storage) | 4 | Non-greasy and crispy texture was maintained |
| | 3 | Fair texture was maintained |
| | 2 | Soggy texture |
| | 1 | Very soggy and greasy texture |
| Adhesion and | 5 | Powder excellently adheres to meat without |
| handling of | | scattering of powder |
| powder | 4 | Powder adheres to meat well with almost no |
| | | scattering of powder |
| | 3 | Powder adheres to meat with scattering of |
| | | powder a little |
| | 2 | Powder poorly adheres to meat with scattering |
| | | of powder |
| | 1 | Powder does not adhere to meat with scattering |
| | | of powder a lot |

TABLE 3

| | | | Compar- | Compar- | Compar- |
|---|---|---|---|---|---|
| Evaluation | Example | Example | ative | ative | ative |
| item | 1 | 2 | Example 1 | Example 2 | Example 3 |
| Texture of | 4.5 | 4.5 | 3.0 | 3.0 | 3.0 |
| meat | | | | | |
| Appearance | 4.5 | 4.5 | 3.0 | 3.5 | 3.0 |
| and texture | | | | | |
| of coating | | | | | |
| Texture of | 4.5 | 4.5 | 1.7 | 2.0 | 1.8 |
| coating | | | | | |
| (after | | | | | |
| 3 hours) | | | | | |
| Adhesion | 4.2 | 4.5 | 3.0 | 3.0 | 3.0 |
| and | | | | | |
| handling | | | | | |
| of powder | | | | | |

### Test Example 2

Except for using a variety of dextrins having different DE values, granular powders were prepared by the same procedure as in Example 1. Using these granular powders, karaage was obtained by the same procedure as in Test Example 1, and handling ease of the granular powders and the appearance and texture of the karaage were evaluated. The evaluation results thus obtained are as shown in Table 4.

TABLE 4

| | Production Example | | | | | | |
|---|---|---|---|---|---|---|---|
| Evaluation item | 1 | 2 | 3 | 4 | 5 | 6 | 7 |
| DE value | 1 | 2 | 5 | 10 | 20 | 25 | 30 |
| Texture of meat | 3.2 | 3.7 | 4.2 | 4.5 | 4.5 | 3.5 | 3.2 |
| Appearance and texture | 3.0 | 3.5 | 4.0 | 4.5 | 4.5 | 3.5 | 3.0 |
| of coating | | | | | | | |
| Texture of coating (after | 3.0 | 3.5 | 4.0 | 4.5 | 4.5 | 4.0 | 2.5 |
| 3 hours) | | | | | | | |
| Adhesion and handling | 3.5 | 3.5 | 4.2 | 4.5 | 4.5 | 3.8 | 3.5 |
| of powder | | | | | | | |

### Test Example 3

Except for changing the conditions of hydrothermal treatment, granular powders were prepared by the same procedure as in Example 1. Using these granular powders, karaage was obtained by the same procedure as in Test Example 1, and handling ease of the granular powders and the appearance and texture of the karaage were evaluated. The evaluation results thus obtained are as shown in Table 5. It is to be noted that Example 1 is re-listed in this Table.

TABLE 5

| | Production Example | | | | | | | |
|---|---|---|---|---|---|---|---|---|
| Evaluation item | 8 | 9 | 10 | Example 1 | 11 | 12 | 13 | 14 |
| Temperature of | 90 | 100 | 103 | 105 | 115 | 120 | 130 | 140 |
| hydrothermal | | | | | | | | |
| treatment (° C.) | | | | | | | | |
| Texture of meat | 4.0 | 4.0 | 4.5 | 4.5 | 4.5 | 4.0 | 3.5 | 3.5 |
| Appearance and | 3.5 | 4.2 | 4.5 | 4.5 | 4.5 | 4.0 | 3.8 | 3.8 |
| texture of coating | | | | | | | | |
| Texture of coating | 3.5 | 3.8 | 4.0 | 4.5 | 4.5 | 3.8 | 3.3 | 3.3 |
| (after 3 hours) | | | | | | | | |
| Adhesion and | 3.5 | 3.8 | 4.2 | 4.2 | 4.5 | 4.5 | 4.5 | 4.5 |
| handling of powder | | | | | | | | |

### Examples 3 to 5

Granular powders (each having an average particle diameter of 80 μm) were produced using raw materials composed of wheat flour (soft wheat flour) and dextrin (DE value: 12) as shown in Table 6 by the same procedure as in Example 1.

### Comparative Example 5

A granular powder (an average particle diameter of 70 μm) was produced using only wheat flour (soft wheat flour) by the same procedure as in Example 3.

### Comparative Examples 6 to 9

Granular powders (each having an average particle diameter of 80 μm) were produced using raw materials composed of wheat flour (soft wheat flour) and starch as shown in Table 6 by the same procedure as in Example 4.

TABLE 6

| | | | | Compar- |
|---|---|---|---|---|
| Raw material | | | | ative |
| (% by mass) | Example 3 | Example 4 | Example 5 | Example 5 |
| Wheat flour | 95 | 90 | 84 | 100 |
| (soft wheat flour) | | | | |
| Dextrin | 5 | 10 | 16 | — |
| DE value | 12 | 12 | 12 | — |
| Hydrothermal | Wheat | Wheat | Wheat | Only wheat |
| treatment | flour + | flour + | flour + | flour |
| | Dextrin | Dextrin | Dextrin | |
| | Mixture | Mixture | Mixture | |
| Particle diameter of | 80 | 80 | 80 | 70 |
| granular powder | | | | |
| | Compar- | Compar- | Compar- | Compar- |
| Raw material | ative | ative | ative | ative |
| (% by mass) | Example 6 | Example 7 | Example 8 | Example 9 |
| Wheat flour | 90 | 90 | 90 | 90 |
| (soft wheat flour) | | | | |
| Potato starch | 10 | — | — | — |
| Tapioca starch | — | 10 | — | — |
| Wheat starch | — | — | 10 | — |
| Corn starch | — | — | — | 10 |
| Hydrothermal | Wheat | Wheat | Wheat | Wheat |
| treatment | flour + | flour + | flour + | flour + |
| | Starch | Starch | Starch | Starch |
| Particle diameter of | 80 | 80 | 80 | 80 |
| granular powder | | | | |

### Test Example 4

A pancake mix was prepared by mixing the ingredients shown in Table 7(A). 75 Parts by mass of milk and 25 parts by mass of eggs were mixed with 100 parts by mass of this pancake mix, and the batter thus obtained was pan-fried on an iron plate heated to 170° C. for 3 minutes on one side, and then for 3 minutes on the other side, whereby a pancake was obtained. 10 Panelists evaluated the texture of the pancake thus obtained based on the evaluation criteria shown in Table 8, and average scores were obtained. The evaluation results are shown in Table 9.

### Test Example 5

An okonomiyaki mix was prepared by mixing the ingredients shown in Table 7(B). 120 Parts by mass of water was mixed with 100 parts by mass of this okonomiyaki mix, into which 300 g of cabbage, two eggs, and 30 g of age-dama (bits of deep-friend tempura batter) were mixed, whereby a batter was prepared. The batter thus obtained was pan-fried on an iron plate heated to 200° C. for 7 minutes on one side, and then for 7 minutes on the other side, whereby okonomiyaki was obtained. 10 Panelist evaluated the texture of the okonomiyaki thus obtained based on the evaluation criteria shown in Table 8, and average scores were obtained. The evaluation results are shown in Table 9.

TABLE 7

| | |
|---|---|
| Ingredients | Amount (%) |

(A) Pancake mix

| | |
|---|---|
| Untreated weak wheat flour | 71.2 |
| Granular powder (Examples 3 to 5 | 5 |
| or Comparative Examples 5 to 9) | |
| Sugar | 20 |
| Glucose | 2 |
| Leavening agent | 1.5 |
| Fragrance | 0.3 |
| Total | 100 |

(B) Okonomiyaki mix

| | |
|---|---|
| Untreated weak wheat flour | 81 |
| Granular powder (Examples 3 to 5 | 5 |
| or Comparative Examples 5 to 9) | |
| Starch | 10 |
| Leavening agent | 2 |
| Salt | 1 |
| Sodium glutamate | 1 |
| Total | 100 |

TABLE 8

| Evaluation item | Score | Evaluation criteria |
|---|---|---|
| Feel when biting | 5 | Crispy and easily bit off |
| | 4 | Insufficient crispness but easily bit off |
| | 3 | Slightly easily bit off |
| | 2 | Feel little difficulty in biting off |
| | 1 | Tough and feel difficulty in biting off |
| Melting in mouth | 5 | Naturally melts while chewing |
| | 4 | Feel a faint firmness while chewing, |
| | | but melts in the mouth |
| | 3 | Feel a little firmness while chewing |
| | 2 | Slightly sticks around on the teeth while |
| | | chewing |
| | 1 | Aggregating into a ball while chewing |
| Moistness | 5 | Very moist, absolutely free from dryness |
| | 4 | Sufficiently moist |
| | 3 | Slightly moist |
| | 2 | Slightly dry |
| | 1 | Dry |

TABLE 9

| | | | | | | | | |
|---|---|---|---|---|---|---|---|---|
| Evaluation | | | | Comparative | Comparative | Comparative | Comparative | Comparative |
| item | Example 3 | Example 4 | Example 5 | Example 5 | Example 6 | Example 7 | Example 8 | Example 9 |

Pancake

| | | | | | | | | |
|---|---|---|---|---|---|---|---|---|
| Feel when | 3.8 | 4.5 | 4.2 | 3.0 | 3.2 | 3.1 | 3.1 | 2.8 |
| biting | | | | | | | | |
| Melting in | 3.9 | 4.5 | 4.7 | 3.0 | 3.0 | 3.2 | 3.3 | 3.0 |
| mouth | | | | | | | | |
| Moistness | 3.7 | 4.1 | 4.0 | 3.0 | 3.0 | 3.1 | 3.1 | 3.1 |

Okonomiyaki

| | | | | | | | | |
|---|---|---|---|---|---|---|---|---|
| Fell when | 4.0 | 4.5 | 4.2 | 3.0 | 3.2 | 3.1 | 3.1 | 2.8 |
| biting | | | | | | | | |
| Melting in | 4.0 | 4.5 | 4.5 | 3.0 | 3.1 | 3.3 | 3.4 | 2.7 |
| mouth | | | | | | | | |
| Moistness | 3.8 | 4.2 | 4.0 | 3.0 | 3.1 | 3.2 | 3.3 | 2.9 |

1. A granular powder obtained by a process comprising subjecting wheat flour and dextrin to a hydrothermal treatment.

2. The granular powder according to claim 1, wherein a mass ratio of the wheat flour and the dextrin, before the hydrothermal treatment, is from 100:5 to 20.

3. The granular powder according to claim 1, wherein a dextrose equivalent of the dextrin before the hydrothermal treatment is from 2 to 25.

4. The granular powder according to claim 1, wherein the hydrothermal treatment is a superheated steam treatment.

5. The granular powder according to claim 1, wherein the hydrothermal treatment comprises: adding water to the wheat flour and the dextrin to obtain a mixture; and then
applying heat to the mixture under pressure.

6. A wheat flour composition comprising a granular powder according to claim 1.

7. The wheat flour composition according to claim 6, wherein the wheat flour composition is a premix for production of a food product comprising wheat flour.

8. A method for producing a food product comprising wheat flour, the method comprising adding a granular powder according to claim 1 to an ingredient.

9. A method for producing a premix for the production of a food product comprising wheat flour, the method comprising adding a granular powder according to claim 1 to an ingredient.

10. A method for improving a texture of a food product comprising wheat flour, the method comprising adding a granular powder according to claim 1 to an ingredient.

11. A wheat flour composition comprising a granular powder according to claim 2.

12. A wheat flour composition comprising a granular powder according to claim 3.

13. A wheat flour composition comprising a granular powder according to claim 4.

14. A method for producing a food product comprising wheat flour, the method comprising adding a granular powder according to claim 2 to an ingredient.

15. A method for producing a food product comprising wheat flour, the method comprising adding a granular powder according to claim 3 to an ingredient.

16. A method for producing a food product comprising wheat flour, the method comprising adding a granular powder according to claim 4 to an ingredient.

17. A method for producing a premix for the production of a food product comprising wheat flour, the method comprising adding a granular powder according to claim 2 to an ingredient.

18. A method for producing a premix for the production of a food product comprising wheat flour, the method comprising adding a granular powder according to claim 3 to an ingredient.

19. A method for improving a texture of a food product comprising wheat flour, the method comprising adding a granular powder according to claim 2 to an ingredient.

20. A method for improving a texture of a food product comprising wheat flour, the method comprising adding a granular powder according to claim 3 to an ingredient.
